(19) United States
(12) Patent Application Publication
(10) Pub. No.: US 2026/0049844 A1
(43) Pub. Date: Feb. 19, 2026

(54) Active Thermal Monitoring of Piezoresistive Angle Transducers

(71) Applicant: Microvision, Inc., Redmond, WA (US)

(72) Inventors: Eleonoor Bosch, Neuchatel (CH); Damian Roesler, Seattle, WA (US); Prerit Pramod, Bellevue, WA (US); Jeremy Simpson, Seattle, WA (US); Dirk Tenne, Bellevue, WA (US); Jonathan Cross, Monroe, WA (US); Christopher Brian Adkins, Woodinville, WA (US); Amin Abbasalipour, Kirkland, WA (US)

(73) Assignee: Microvision, Inc., Redmond, WA (US)

(21) Appl. No.: 18/802,092

(22) Filed: Aug. 13, 2024

(51) Int. Cl. G01D 5/16; G01K 7/02; G01L 1/16; G01S 7/481

(52) U.S. Cl. CPC G01D 5/16; G01K 7/02; G01L 1/16; G01S 7/4814; G01S 7/4817

(57) ABSTRACT

Aspects of the subject disclosure may include, for example, temperature compensation for angle estimation in micro-electromechanical systems (MEMS) devices. A plurality of piezoelectric strain sensors are arranged in a Wheatstone bridge that produces a voltage that varies with torsional movement of the MEMS device. Temperature dependent coefficients that represent temperature dependency of substrate materials and temperature dependency of the voltage produced by the Wheatstone bridge in response to the torsional movement. The temperature dependent coefficients are used to scale the voltage produced by the Wheatstone bridge to provide temperature compensated angle estimation. Other embodiments are disclosed.

### FIELD OF THE DISCLOSURE

The subject disclosure relates to micro-electromechanical systems (MEMS) with piezoresistive (PZR) angle transducers.

### BACKGROUND

MEMS devices are useful as very small machines that are capable of movement. The movement of MEMS devices may be monitored using different mechanisms. For example, a piezoelectric strain sensor may be placed on a MEMS device, and a property of the piezoelectric strain sensor may change when the MEMS device moves. The movement of the MEMS device may then be monitored by measuring the property of the piezoelectric strain sensor.

### BRIEF DESCRIPTION OF THE DRAWINGS

Reference will now be made to the accompanying drawings, which are not necessarily drawn to scale, and wherein:

FIG. 1 shows a LIDAR system with scanning mirror assemblies in accordance with various aspects described herein;

FIG. 2 shows an automotive application of a LIDAR system with scanning mirror assemblies in accordance with various aspects described herein;

FIG. 3 shows a block diagram of a control circuit in accordance with various aspects described herein;

FIG. 4 shows a scanning mirror assembly in accordance with various aspects described herein;

FIG. 5 shows a scanning mirror assembly without a mirror in accordance with various aspects described herein;

FIG. 6 shows piezoelectric strain sensors arranged in a Wheatstone bridge in accordance with various aspects described herein;

FIG. 7 shows the Wheatstone bridge of FIG. 6 with a shunt resistor for indirect thermal sensing in accordance with various aspects described herein;

FIG. 8 shows the Wheatstone bridge of FIG. 6 with a current mirror for indirect thermal sensing in accordance with various aspects described herein;

FIG. 9 shows a MEMS control system with thermal compensation in accordance with various aspects described herein;

FIG. 10 shows a side view of a transmit module in accordance with various aspects described herein;

FIG. 11 shows a top view of a transmit module in accordance with various aspects described herein;

FIG. 12 shows a side view of a receive module in accordance with various aspects described herein;

FIG. 13 shows a top view of a receive module in accordance with various aspects described herein;

FIG. 14 shows a perspective view of an integrated photonics module in accordance with various aspects described herein;

FIG. 15 shows a cross sectional top view of the integrated photonics module of FIG. 14; and

FIG. 16 depicts an illustrative embodiment of a method in accordance with various aspects described herein.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. Like numerals in the drawings refer to the same or similar functionality throughout the several views.

One or more aspects of the subject disclosure include a system, comprising a micro-electromechanical systems (MEMS) device capable of torsional movement, a circuit including a plurality of piezoelectric (PZR) strain sensors coupled to the MEMS device to produce a first voltage that varies with the torsional movement, and a thermal sensor to produce a measured temperature signal indicative of a temperature of the plurality of PZR strain sensors. The system may also include a processing system including a processor, the processing system coupled to receive the first voltage and the measured temperature signal, and a memory that stores executable instructions that, when executed by the processing system, facilitate performance of operations. The operations may include determining a proportionality coefficient that represents a temperature dependent variation of the first voltage in response to the torsional movement, and estimating an instantaneous angle of the torsional movement of the MEMS device by scaling the first voltage by the proportionality coefficient.

One or more aspects of the subject disclosure include a system, comprising a micro-electromechanical systems (MEMS) device capable of torsional movement, a circuit including a plurality of piezoelectric (PZR) strain sensors coupled to the MEMS device to produce a first voltage that varies with the torsional movement; and a thermal sensor to produce a measured temperature signal indicative of a temperature of the plurality of PZR strain sensors. The system may include a processing system including a processor, the processing system coupled to receive the first voltage and the measured temperature signal, and a memory that stores executable instructions that, when executed by the processing system, facilitate performance of operations. The operations may include determining a first temperature dependent coefficient that represents a change in resistance of each PZR strain sensor of the plurality of PZR strain sensors as a function of the measured temperature signal, determining a second temperature dependent coefficient that represents a temperature dependent variation of the first voltage in response to the torsional movement, determining a ratio of the first temperature dependent coefficient to the second temperature dependent coefficient, and estimating an instantaneous angle of the torsional movement of the MEMS device by scaling the first voltage by the ratio as part of a proportionality coefficient.

One or more aspects of the subject disclosure include a light detection and ranging (LIDAR) system that comprises a laser light source to produce laser light pulses, a transmit mirror to reflect the laser light pulses, the transmit mirror being mounted to a first micro-electromechanical systems (MEMS) device capable of torsional movement, a light detector, a receive mirror to reflect received laser light pulses to the light detector, the receive mirror being mounted to a second micro-electromechanical systems (MEMS) device capable of torsional movement, a first circuit including a first plurality of piezoelectric (PZR) strain sensors coupled to the first MEMS device to produce a first voltage that varies with the torsional movement of the first MEMS device, a second circuit including a second plurality of PZR strain sensors coupled to the second MEMS device to produce a second voltage that varies with the torsional movement of the second MEMS device, a first thermal sensor to produce a first measured temperature signal indicative of a first temperature of the first plurality of PZR strain sensors, and a second thermal sensor to produce a second measured temperature signal indicative of a second temperature of the second plurality of PZR strain sensors. The LIDAR system may include a processing system including a processor, the processing system coupled to receive the first and second voltages and the first and second measured temperature signals, and a memory that stores executable instructions that, when executed by the processing system, facilitate performance of operations. The operations may include determining separate proportionality coefficients for the first and second MEMS devices that represents temperature dependent variations of the first voltage and the second voltage in response to torsional movement, and estimating instantaneous angles of the torsional movement of the first and second MEMS devices by scaling the first voltage and the second voltage by the separate proportionality coefficients.

Additional aspects of the subject disclosure include the thermal sensor comprising a direct temperature measurement device, such as a thermocouple, or an indirect temperature measurement device, such as shunt resistor or current mirror to measure a total current in a Wheatstone bridge circuit. The circuit that includes the plurality of PZR strain sensors may include a Wheatstone bridge, and the thermal sensor may include a second circuit to measure a total current in the Wheatstone bridge. The second circuit may include a shunt resistor or a current mirror in series with the Wheatstone bridge.

Additional aspects of the subject disclosure include characterizing a temperature dependency of a resistance of a sample piezoelectric strain sensor in response to torsional movement, and wherein the determining the proportionality coefficient comprises evaluating the temperature dependency at the temperature of the plurality of PZR strain sensors indicated by the measured temperature signal; commanding the MEMS device to undergo torsional movement at a commanded angle; and determining the commanded angle based at least in part on the instantaneous angle estimated using the proportionality coefficient.

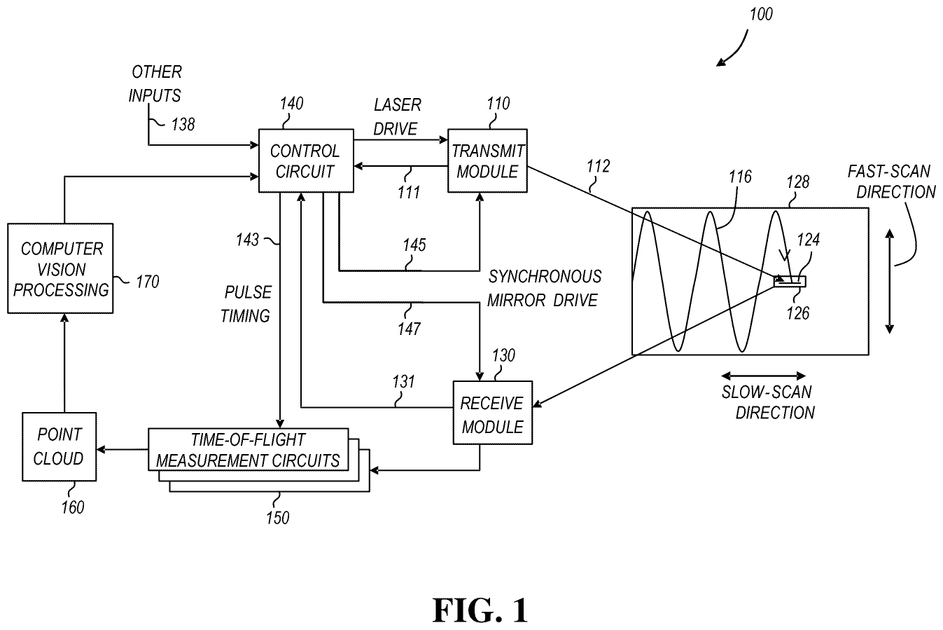

FIG. 1 shows a LIDAR system with scanning mirror assemblies in accordance with various aspects described herein. System 100 includes control circuit 140, transmit module 110, receive module 130, time-of-flight (TOF) measurement circuits 150, point cloud storage device 160, and computer vision processing 170.

Transmit module 110 emits a scanning pulsed laser beam 112 that traverses a field of view 128 in two dimensions. In some embodiments, the scanning pulsed laser beam 112 is a fanned beam. The shape of the fanned beam is shown at 124, and the scanning trajectory that the pulsed fanned beam takes through the field of view is shown at 116. To produce the scanning pulsed fanned beam, transmit module 110 includes a laser light source to produce a pulsed laser beam, collimating and focusing optics to shape the pulsed laser beam into a pulsed fanned laser beam, and one or more scanning mirror assemblies to scan the pulsed fanned laser beam in two dimensions in the field of view. Example embodiments of transmit modules are described more fully below with reference to later figures.

In some embodiments, receive module 130 includes an arrayed receiver that includes a plurality of light sensitive devices. Receive module 130 also includes optical devices and one or more scanning mirror assemblies to scan in two dimensions and to direct reflected light from the field of view to the arrayed receiver. As shown in FIG. 1, receive module 130 captures reflected light from an aperture 126 that encompasses the location of the fanned beam in the field of view. Example embodiments of receive modules are described more fully below with reference to later figures.

The reflected fanned beam becomes “discretized” by the array of light sensitive devices, and the corresponding points in the field of view from which the beam is reflected are referred to herein as “measurement points.”

As used herein, the term “fanned beam” refers to a beam of light that has been purposely shaped to encompass more measurement points in one dimension than in another dimension. For example, as shown in FIG. 1, fanned beam 112 includes shape 124 that encompasses more measurement points in the horizontal dimension than in the vertical dimension. Although fanned beam embodiments are further described below, the subject matter described herein is not limited to fanned beam embodiments. For example, in some embodiments, the scanning pulsed laser beam 112 may be a collimated beam that is not fanned in either dimension.

Time-of-flight (TOF) measurement circuits 150 are each coupled to one of the light sensitive devices in the arrayed receiver to measure a time-of-flight of a laser pulse. TOF measurement circuits 150 receive laser light pulse timing information 143 from control circuit 140 and compare it to the timing of received laser light pulses to measure round trip times-of-flight of light pulses, thereby measuring the distance (Z) to the point in the field of view from which the laser light pulse was reflected. Accordingly, TOF measurement circuits 150 measure the distance between LIDAR system 100 and measurement points in the field of view at which light pulses from the scanned fanned beam are reflected.

TOF measurement circuits 150 may be implemented with any suitable circuit elements. For example, in some embodiments, TOF measurement circuits 150 include digital and/or analog timers, integrators, correlators, comparators, registers, adders, or the like to compare the timing of the reflected laser light pulses with the pulse timing information received from control circuit 140.

Point cloud storage 160 receives TOF information corresponding to distance (Z) information from TOF measurement circuits 150. In some embodiments, the TOF measurements are held in point cloud storage 160 in an array format such that the location within point cloud storage 160 indicates the location within the field of view from which the measurement was taken. In other embodiments, the TOF measurements held in point cloud storage 160 include (X, Y) position information as well as TOF measurement information to yield (X, Y, Z) as a three-dimensional (3D) data set that represents a depth map of the measured portion of the field of view 128. The point cloud data may then be used for any suitable purpose. Examples include 3D imaging, velocity field estimation, object recognition, adaptive field of view modifications, and the like.

Point cloud storage 160 may be implemented using any suitable circuit structure. For example, in some embodiments, point cloud storage 160 is implemented in a dual port memory device that can be written on one port and read on a second port. In other embodiments, point cloud storage 160 is implemented as data structures in a general purpose memory device. In still further embodiments, point cloud storage 160 is implemented in an application specific integrated circuit (ASIC).

Computer vision processing 170 performs analysis on the point cloud data and provides feedback to control circuit 140. For example, in some embodiments, computer vision processing 170 performs object identification, classification, and tracking within the field of view, and provides this information to control circuit 140. Computer vision processing 170 may take any form, including neural networks of any depth, convolutional neural nets, traditional vision processing methods, and the like. In some embodiments, computer vision processing 170 is omitted.

Control circuit 140 determines laser drive properties and drives transmit module 110 with signal(s) that cause the light source to emit laser light pulses having the specified properties. For example, control circuit 140 may determine values for laser drive power, pulse rate, pulse width, and number of multishot pulses. Further, as described more fully below, control circuit 140 may adaptively modify the laser drive properties in response to feedback from computer vision processing 170 or in response to other inputs 138.

Control circuit 140 also controls the movement of scanning mirrors within transmit module 110 and receive module 130. In operation, control circuit 140 receives mirror position feedback information 111 from transmit module 110, and also receives mirror position feedback information 131 from receive module 130. The mirror position feedback information is used to phase lock the operation of the mirrors. Control circuit 140 drives microelectromechanical (MEMS) assemblies with scanning mirrors within transmit module 110 with drive signal(s) 145 and also drives MEMS assemblies with scanning mirrors within receive module 130 with drive signal(s) 147 that cause the mirrors to move non-resonantly through angular extents of mirror deflection with angular offsets that define the size and location of field of view 128. Control circuit 140 synchronizes the movement between mirrors in transmit module 110 and receive module 130 so that area 126 is continually positioned in the field of view to receive light reflected from objects that are illuminated with pulsed fanned beam 112. The synchronization of transmit and receive scanning allows the receive aperture to only accept photons from the portion of the field of view where the transmitted energy was transmitted. This results in significant ambient light noise immunity.

Control circuit 140 is implemented using functional circuits such as phase lock loops (PLLs), filters, adders, multipliers, registers, processors, memory, and the like. Accordingly, control circuit 140 may be implemented in hardware, software, or in any combination. For example, in some embodiments, control circuit 140 is implemented in an application specific integrated circuit (ASIC). Further, in some embodiments, some of the faster data path control is performed in an ASIC and overall control is software programmable.

As shown in FIG. 1, the two dimensional scanning is performed in a first dimension (vertical, fast scan direction) and a second dimension (horizontal, slow scan direction). The labels “vertical” and “horizontal” are somewhat arbitrary, since a 90 degree rotation of the apparatus will switch the horizontal and vertical axes. Accordingly, the terms “vertical” and “horizontal” are not meant to be limiting.

The scanning trajectory in the fast scan direction is shown as sinusoidal, and the scanning trajectory in the slow scan direction is shown as constant velocity, although this is not a limitation. In some embodiments, all mirror motion is operated non resonantly. Accordingly, a relatively flat control band exists down to and including OHz. This allows a drive signal to be generated to cause the pointing angle (boresight) of the LIDAR system to deflect to a desired position in two dimensions (azimuth & elevation) of a spherical coordinate space, offset from the mirror relaxation point.

The angular extents of mirror deflection of both the transmit and receive modules can be adjusted to change the active field of view of the LIDAR system. The scanning mirror assemblies are designed for reliable operation at some maximum angle of deflection along each scan axis. From that nominal/max operating point, the drive amplitude may be reduced to collapse the deflection angle and narrow the active field of view. All else being equal, this results in a proportional increase in the angular resolution of the acquired scene.

In some embodiments, it is beneficial to trade off surplus angular resolution for increased range of measurement. For example, reducing the pulse repetition rate allows for a longer flight time in between adjacent pulses, eliminating range aliasing out to a proportionally larger distance. Accordingly, a balance exists such that reducing the field of view increases the non-ambiguous range of the LIDAR system without changing the angular resolution of the acquired scene. In some embodiments, laser power modifications are performed as a complement to increased range. For example, the laser power may be scaled as the square of the proportional increase in range.

Though the scanned field of view, pulse repetition rate, and laser power may all be independently controlled by software configuration, in some embodiments, it may be desirable to also design them to be commanded in a coordinated manner, automatically under hardware control.

Pulse width may also be controlled in the same manner in order to augment the scaled distance of interest. As the pulse width is increased, additional energy is deposited into the scene, increasing the likelihood of a sufficient number of photons returning to the receiver to trip the detection threshold. In some embodiments, increasing the pulse width is only performed when the peak power is maxed out as a wider pulse increases time resolution error for weak returns. This tradeoff is often warranted and useful as absolute time/distance resolution is typically not as important as percentage error which self-normalizes with distance.

Pulse energy may also be augmented by means of a train of shorter multishot pulses. The number of pulses may be varied to achieve the desired amount of energy in addition to or in place of modification of the pulse width.

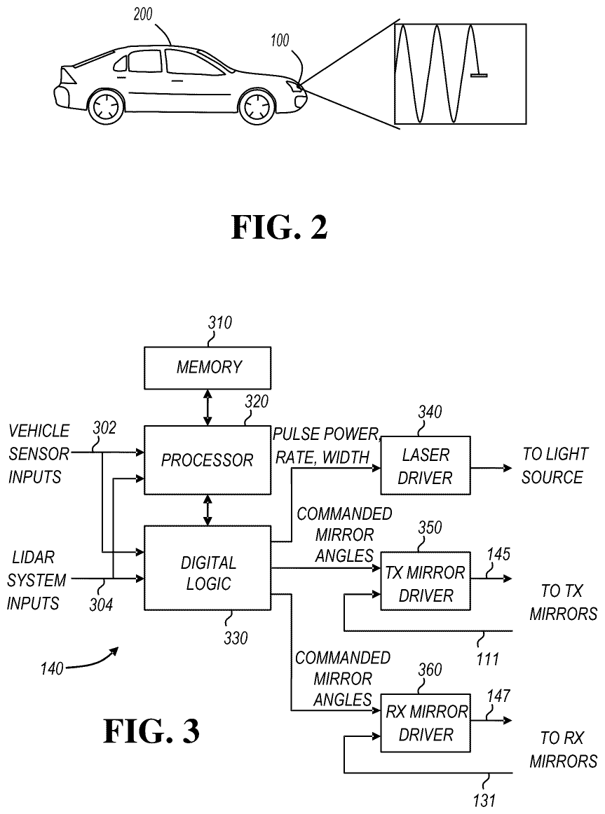

FIG. 2 shows an automotive application of a LIDAR system with scanning mirror assemblies in accordance with various aspects described herein. As shown in FIG. 2, vehicle 200 includes LIDAR system 100 at the front of the vehicle. LIDAR system 100 synchronously scans transmit and receive scanning mirrors such that receiver aperture 126 substantially overlaps the shape 124 of the pulsed fanned beam. Although much of the remainder of this description describes the LIDAR system in the context of an automotive application, the various embodiments described herein are not limited in this respect.

FIG. 3 shows a block diagram of a control circuit in accordance with various aspects described herein. The example embodiment shown in FIG. 3 corresponds to a control circuit that may be included when LIDAR system 100 is used in an automotive application. Other control circuit embodiments may be employed when used in applications other than automotive applications. Control circuit 140 includes processor 320, memory 310, digital logic 330, laser driver 340, transmit mirror driver 350, and receive mirror driver 360. Control circuit 140 receives vehicle sensor inputs at 302 and LIDAR system inputs at 304. Vehicle sensor inputs may include any type of data produced by sensors on a vehicle. Examples include data describing vehicle position, speed, acceleration, direction. Other examples include sensor data received from adaptive driver assistance systems (ADAS) or other vehicle mounted sensors. LIDAR system inputs may include any data gathered or produced by the LIDAR system. Examples include computer vision processing results, internal inertial measurement unit data, and the like.

Processor 320 may include any type of processor capable of executing instructions stored in a memory device. For example, processor 320 may be a microprocessor, a digital signal processor, or a microcontroller. Processor 320 may also be a hard-coded processor such as a finite state machine that provides sequential flow control without fetching and executing instructions.

Memory 310 may be any device that stores data and/or processor instructions. For example, memory 310 may be a random access memory device that stores data. In some embodiments, memory 310 is a non-transitory storage device that stores instructions, that when accessed by processor 320 result in processor 320 performing actions. For example, in some embodiments, processor 320 executes instructions stored in memory 310 and performs method embodiments.

Digital logic 330 receives vehicle sensor inputs at 302 and LIDAR system inputs at 304 and outputs information used to control a laser light source and scanning mirrors. Digital logic 330 may produce the outputs based solely on the vehicle sensor data and/or LIDAR system data, may produce the outputs based solely on interactions with processor 320, or may produce the outputs based on a combination of the vehicle sensor data, LIDAR system data, and interaction with processor 320. For example, in some embodiments, digital logic 330 modifies laser light pulse parameters such as pulse power, repetition rate, pulse width, and number of multishot pulses in response to vehicle sensor data and/or LIDAR system data. Also for example, in some embodiments, digital logic 330 modifies angular extents and angular offsets used to drive the scanning mirrors in the transmit module and receive module in response to vehicle sensor data and/or LIDAR system data.

In some embodiments, digital logic 330 provides output data under software control via interaction with processor 320. For example, processor 320 may determine values for any of the outputs in response to vehicle sensor data and/or LIDAR system data, and then command digital logic under software control. In other embodiments, digital logic 330 may provide output data under hardware control independent of processor 320. For example, an adaptive model may be programmed into digital logic 330 in advance, and digital logic 330 may then modify outputs as a function vehicle sensor data and/or LIDAR system data at a much faster rate.

Laser driver 340 receives laser light properties from digital logic 330 and drives the laser light source. For example, laser driver 340 may receive property values for pulse power, pulse repetition rate, pulse width, and number of multishot pulses, and produce an analog signal to drive a laser light source. Laser driver 340 may be implemented with any suitable circuit elements including for example, high speed signal generators, amplifiers, filters, and the like.

Mirror drivers 350, 360 commanded mirror angle information from digital logic 330 and mirror position feedback information 111, 131, and produce drive signals 145, 147 to cause scanning mirrors in modules 110, 130 to undergo motion. Transmit mirror driver 350 and receive mirror driver 360 may be implemented using any suitable circuit structures including for example, phase lock loops, numerically controlled oscillators, filters, amplifiers, and the like. In some embodiments, mirror position feedback information 111, 131 includes measured mirror angle information as well as measured temperature information. Mirror drivers use the measured temperature information to compensate for angle measurement errors as a function of temperature. These and other embodiments are further described below.

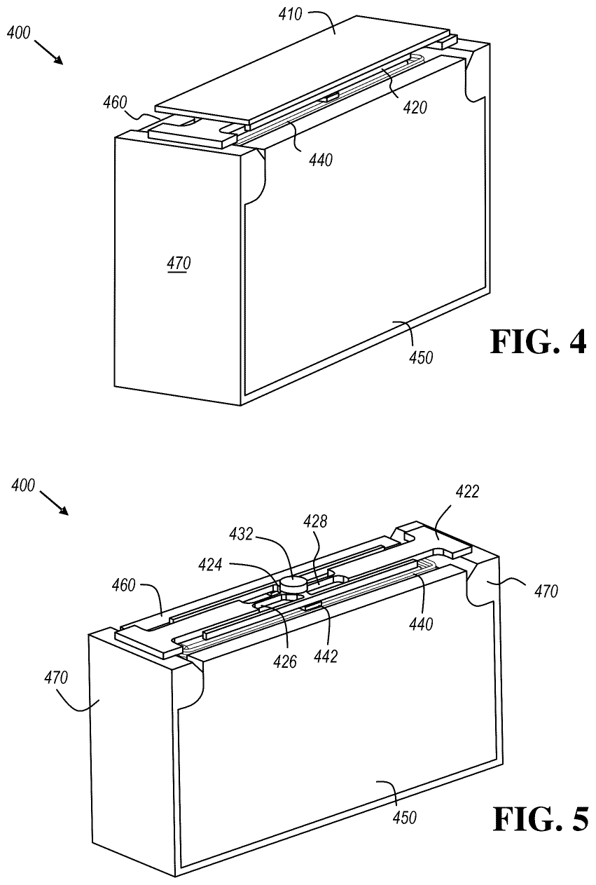

FIG. 4 shows a scanning mirror assembly and FIG. 5 shows the scanning mirror assembly with the mirror removed in accordance with various aspects described herein. Scanning mirror assembly 400 may be used to implement any of the scanning mirror assemblies described herein. For example, any of scanning mirror assemblies 1030, 1040, 1230, and 1240 described below may be implemented with scanning mirror assembly 400.

Scanning mirror assembly 400 includes mirror 410, Microelectromechanical system (MEMS) device 420, conductive coil 440, magnetically permeable components 450, 460, and housing 470. MEMS device 420 includes fixed platforms 422 and scanning platform 424. Scanning platform 424 is coupled to fixed platforms 422 by flexures 426, 428. Mirror 410 is affixed to scanning platform 424 by adhesive 432. Fixed platforms 422 are affixed to housing 470.

The axis of flexures 426, 428 forms a pivot axis. Flexures 426, 428 are flexible members that undergo a torsional flexure, also referred to herein as torsional movement, thereby allowing scanning platform 424 to rotate on the pivot axis and have an angular displacement relative to fixed platforms 422. Flexures 426, 428 are not limited to torsional embodiments as shown in FIG. 5. For example, in some embodiments, flexures 426, 428 take on other shapes such as arcs, “S” shapes, or other serpentine shapes.

MEMS device 420 also incorporates a plurality of piezoresistive strain sensors. In some embodiments, the plurality of piezoresistive strain sensors are positioned on or near one of flexures 426, 428 to produce a voltage that represents the angular displacement of scanning platform 424 with respect to fixed platforms 422. The piezoresistive sensor(s) are coupled to electrical contacts (not shown) on fixed platforms 422 so that position feedback signal(s) may be provided to control circuit 140 (FIGS. 1, 3).

Much of MEMS device 420 can be fabricated from a single common substrate using MEMS techniques. For example, the fixed platforms 422, the scanning platform 424 and the two flexures 426, 428 can all be formed from the same substrate. Additionally, in some embodiments, conductive signal traces, contacts, and piezoresistive strain sensors can also be formed with any suitable MEMS technique. For example, the signal traces, contacts, and piezoresistive strain sensors can be formed by the selective deposition and patterning of conductive materials on the substrate.

Scanning mirror assembly 400 also includes a conductive coil 440 affixed to the underside of scanning platform 424 by adhesive 442. In operation, a current is induced in conductive coil 440 to create a magnetic field. The interaction of the magnetic field produced by conductive coil 440 with a magnetic field produced by one or more permanent magnets (not shown in FIGS. 4, 5) creates Lorentz forces on scanning platform 424 and results in an angular displacement of mirror 410 as a function of drive current in conductive coil 440.

Housing 470 may be made of any suitable material. For example, in some embodiments, housing 470 is plastic. Fixed platforms 422 may be affixed to housing 470 using any suitable technique, including fasteners or adhesive.

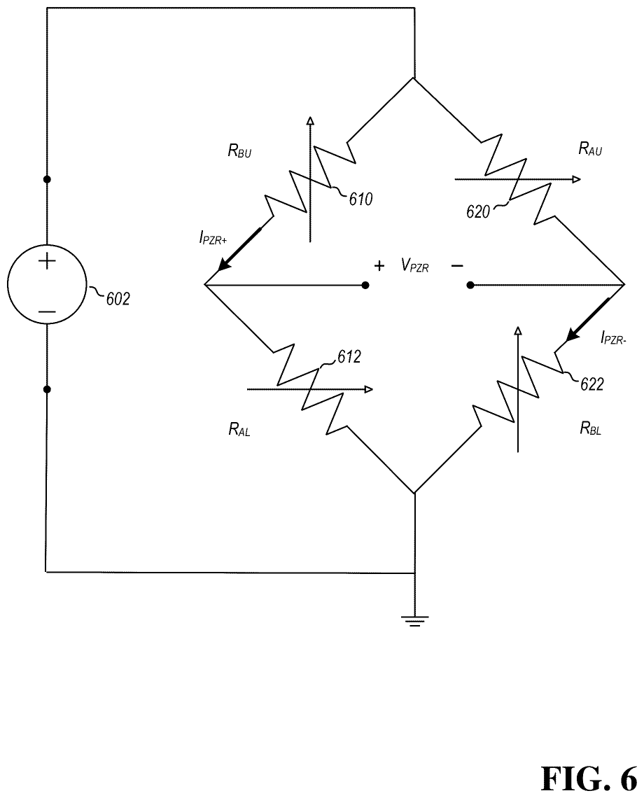

FIG. 6 shows piezoelectric strain sensors arranged in a Wheatstone bridge in accordance with various aspects described herein. Piezoelectric strain sensors 610, 612, 620, and 622 are arranged in a Wheatstone bridge to generate the voltage V_{PZR}. The Wheatstone bridge is in parallel with a voltage source 602 that provides voltage V_{b}. Piezoelectric strain sensor 610 is also referred to as R_{BU}, piezoelectric strain sensor 612 is also referred to as R_{AL}, piezoelectric strain sensor 620 is also referred to as R_{AU}, and piezoelectric strain sensor 622 is also referred to as R_{BL}. Piezoelectric strain sensors exhibit a change in resistance as a function of strain. When placed appropriately near flexures 426, 428 (FIG. 5), the change in resistance may be used to determine an instantaneous angular displacement of the MEMS device.

The “A” subscript on the piezoelectric strain sensors R_{AU} and R_{AL} denotes that the resistance of both strain sensors have the same angle dependency in terms of sign. For example, when the MEMS device undergoes a torsional movement with a positive angle, then both R_{AU} and R_{AL} will decrease in resistance, and when the MEMS device undergoes a torsional movement with a negative angle, then both R_{AU} and R_{AL} will increase in resistance. The “B” subscript on the piezoelectric strain sensors R_{BU} and R_{BL} denotes that the resistance of both strain sensors have the same angle dependency in terms of sign, and that dependency is opposite of the dependency of the strain sensors with the “A” subscript. For example, when the MEMS device undergoes a torsional movement with a positive angle, then both R_{BU} and R_{BL} will increase in resistance, and when the MEMS device undergoes a torsional movement with a negative angle, then both R_{BU} and R_{BL} will decrease in resistance. The “U” and “L” subscripts denote “upper” and “lower” which refers to the location of the placement of the piezoresistive strain sensors on the MEMS device.

The angle dependent resistance of each piezoelectric strain sensor Rᵢⱼ (where i is A or B, and j is U or L), including their variation with temperature, can be modeled as specified in Equation (1).

$${R}_{i j} = {R}_{i j \vert 0} ( {N}_{r} + {γ}_{i} {N}_{θ} {K}_{i j \vert 0} θ ) \qquad ( 1 )$$

where R_{ij|0} z is the nominal resistance of each PZR strain sensor at a specific nominal temperature T₀, Nᵣ and N_{θ} represent the temperature dependence of piezoelectric strain sensor resistance due to material thermal characteristics and distribution of the strain in the substrate respectively, T is the actual piezoelectric strain sensor temperature, K_{ij|0} is the nominal sensitivity at nominal temperature T₀, θ is the torsional angle of the piezoelectric strain sensor, and γᵢ is a fixed constant whose value for a loaded flexure is related to the location of the resistor in the bridge as expressed in Equation (2).

$${γ}_{i} = \{ \begin{matrix}- 1 , & i = A \\ 1 , & i = B\end{matrix} \qquad ( 2 )$$

The thermal behavior of piezoelectric strain sensors is captured in part by Nᵣ which varies based on the deviation of the actual temperature T from the nominal temperature T₀ of the piezoelectric strain sensors and may be expressed as Equation (3) generally.

$${N}_{r} = 1 + {α}_{r} ( T - {T}_{0} ) + δ {N}_{r} \qquad ( 3 )$$

where αᵣ is a coefficient of temperature variation, and δNᵣ is a term that captures any non-linear temperature behavior of the piezoelectric strain sensors and may therefore depend on both the actual nominal temperature T and the nominal temperature T₀. Note that αᵣ is positive for most of the commonly used piezoelectric substrates resulting in an increase in resistance as temperature increases.

The thermal behavior of sensitivity of angle dependency as a function of temperature of piezoelectric strain sensors is captured by N_{θ} which varies based on the deviation of actual temperature T from the nominal temperature T₀ of the piezoelectric strain sensors and may be expressed as Equation (4) generally.

$${N}_{θ} = 1 + {α}_{θ} ( T - {T}_{0} ) + δ {N}_{θ} \qquad ( 4 )$$

where α_{θ} is a coefficient of temperature variation, and δN_{θ} is a term that captures any non-linear temperature behavior of the piezoelectric strain sensors and may therefore depend on both the actual nominal temperature T and the nominal temperature T₀. Note that α_{θ} is negative for most of the commonly used piezoelectric substrates resulting in a decrease in sensitivity of angle dependency as temperature increases.

In some embodiments, values for αᵣ, δNᵣ, α_{θ}, and δN_{θ} are found by characterizing a sample piezoelectric strain sensor. For example, the resistance of a piezoelectric strain sensor may be measured while subject to temperature variations and rotational angles, and the resulting data may be used to generate values (or functions) for αᵣ, δNᵣ, α_{θ}, and δN_{θ}. Generally, αᵣ and d_{θ} are constants to capture any linear behavior component of the temperature dependencies. Nonlinear behavior components of the temperature dependencies are captured by δNᵣ and δN_{θ}, and may be represented in any manner. For example, in some embodiments, δNᵣ and δN_{θ} may be represented by look-up tables with data describing the non-linear temperature dependent behaviors. Also for example, in some embodiments, δNᵣ and δN_{θ} may be represented in closed form, such as multivariate polynomials of the actual temperature T and the nominal temperature T₀.

Assuming that the PZR strain sensors are balanced, the induced voltage V_{PZR} may then be obtained as described in Equation (5).

$${V}_{P Z R} = \frac{{K}_{0}}{{R}_{0}} \frac{{N}_{θ}}{{N}_{r}} θ \qquad ( 5 )$$

where R₀ and K₀ represent the nominal resistance and sensitivity of each PZR strain sensor respectively.

Compensating for temperature dependent behaviors of the piezoelectric strain sensors requires a value for temperature T. Various embodiments described herein determine a value for T using different mechanisms. For example, some embodiments perform a direct temperature measurement (e.g., using a thermocouple coupled to a MEMS device). Also for example, some embodiments perform indirect measurements to measure a quantity that is indicative of temperature. Various indirect measurement methods are described below with reference to later figures.

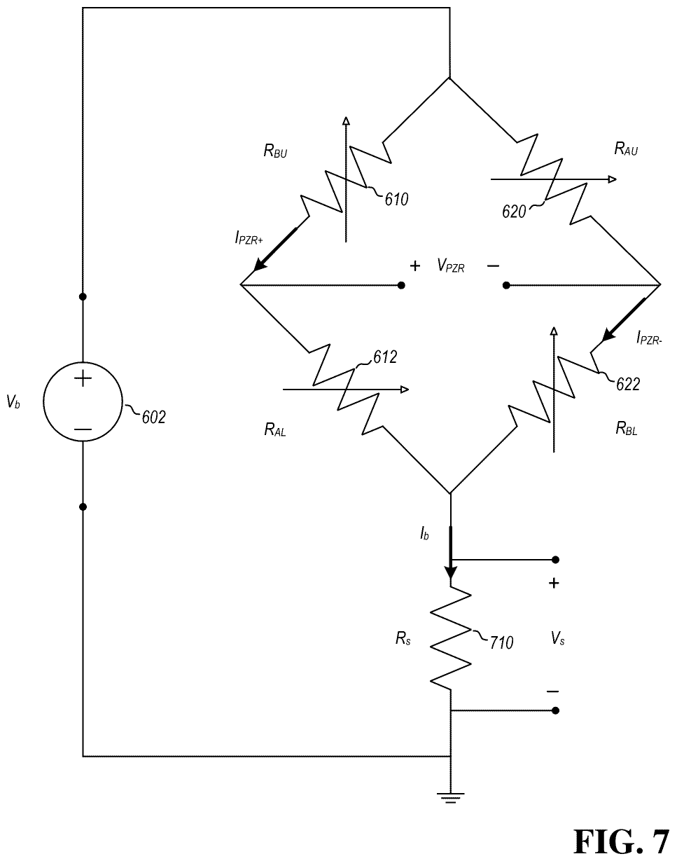

FIG. 7 shows the Wheatstone bridge of FIG. 6 with a shunt resistor for indirect thermal sensing in accordance with various aspects described herein. FIG. 7 shows a specific indirect thermal sensing technique involving measurement of the bias current I_{b} in the Wheatstone bridge of FIG. 6. A shunt resistor 710 (shown as Rₛ) is placed in series with the Wheatstone bridge to measure the bias current I_{b}, resulting in sense voltage Vₛ as expressed in Equation (6).

$${I}_{b} = \frac{{V}_{b}}{{R}_{s} + {R}_{q}} \\ {R}_{q} = {N}_{r} {R}_{0} \\ {V}_{s} = {R}_{s} {I}_{b} = \frac{{R}_{s}}{{R}_{s} + {R}_{q}} {V}_{b} \qquad ( 6 )$$

where R₀ is the nominal resistance for the balanced piezoelectric strain sensors, and R_{q} is the equivalent bridge resistance and varies with temperature. Thus, the sense voltage may be used to obtain the estimated piezoelectric strain sensor temperature.

The sense voltage Vₛ may be used to obtain the temperature dependent estimated term \hat{N}ᵣ as expressed in the Equation (7).

$${\hat{N}}_{r} = \frac{{\hat{R}}_{s}}{{\hat{R}}_{0}} ( \frac{{\hat{V}}_{b}}{{\hat{V}}_{s}} - 1 ) \qquad ( 7 )$$

where the accent “hat” represents estimated versions of true quantities defined previously.

Selecting an analytical model capturing linear temperature variation of the piezoelectric strain sensor, for instance, along with the determination of N, as specified in Equation (7) could yield the temperature estimate as expressed in Equation (8).

$${\hat{N}}_{r} = 1 + {\hat{α}}_{r} ( \hat{T} - {\hat{T}}_{0} ) \hat{T} = {\hat{T}}_{0} + \frac{1}{{\hat{α}}_{r}} ( \frac{{\hat{R}}_{s}}{{\hat{R}}_{0}} ( \frac{{\hat{V}}_{b}}{{\hat{V}}_{s}} - 1 ) - 1 ) \qquad ( 8 )$$

For simplicity, Equation (8) only incorporates the coefficient αᵣ of the linear term of Nᵣ, however the various embodiments described herein are not so limited. For example, nonlinear terms of \hat{N}ᵣ may be included in the calculation for \hat{T}.

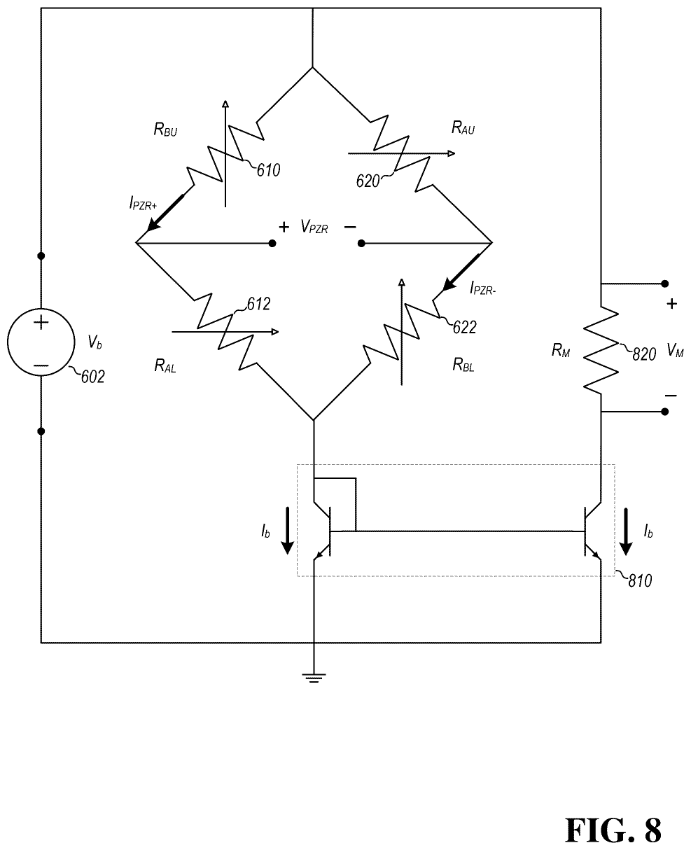

FIG. 8 shows the Wheatstone bridge of FIG. 6 with a current mirror for indirect thermal sensing in accordance with various aspects described herein. The circuit of FIG. 8 includes a current mirror 810 in place of the resistor Rₛ shown in FIG. 6. The I_{b} current in the Wheatstone bridge is duplicated and passed through a sensing resistor 820 shown as R_{M}. The measurement of voltage V_{M} allows an indirect measurement of I_{M}, which can be used to estimate \hat{T} in a manner similar to that described above with reference to FIG. 6.

Two methods for indirect thermal sensing (shunt resistor and current mirror) have been described, although the various embodiments are not limited to these two methods. Any circuit capable of measuring the total current through the Wheatstone bridge may be utilized to indirectly measure the temperature of the piezoelectric strain sensors. Further, any type of direct temperature measurement may also be employed.

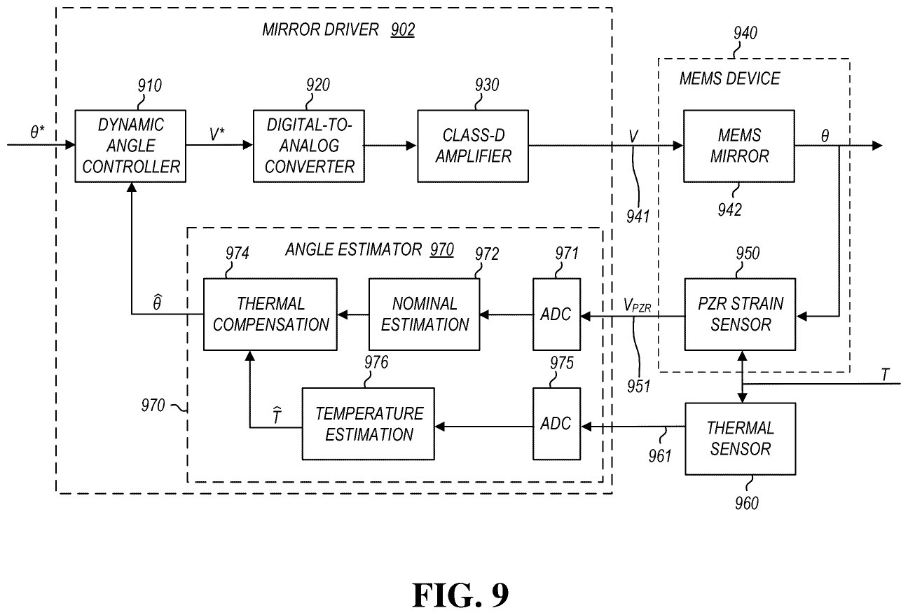

FIG. 9 shows a MEMS control system with thermal compensation in accordance with various aspects described herein. The MEMS control system of FIG. 9 includes mirror driver 902, MEMS device 940, and thermal sensor 960.

MEMS device 940 may be any type of MEMS device that is capable of torsional movement. Example scanning mirror embodiments of MEMS devices are shown in FIGS. 4 and 5 (and later figures described further below). The various embodiments described herein are not limited to scanning mirror embodiments or LIDAR system embodiments. Any MEMS device capable of undergoing an angular movement may benefit from the embodiments described herein.

MEMS device 940 includes a MEMS mirror that is capable of undergoing a torsional movement. For example, in response to a voltage V applied at node 941, MEMS mirror 942 undergoes an angular displacement of 0. MEMS device 940 also includes PZR strain sensor 950. In some embodiments, PZR strain sensor 950 includes a plurality of strain sensors in a Wheatstone bridge configuration as described above with reference to FIG. 6. PZR strain sensor 950 produces a measured voltage V_{PZR} corresponding to the angle θ (FIGS. 6-8) on node 951.

The MEMS control system of FIG. 9 also includes thermal sensor 960 to provide a measured temperature signal on node 961 indicative of a temperature of the MEMS device. In some embodiments, thermal sensor 960 directly measures a temperature of a MEMS device or a PZR strain sensor. For example, thermal sensor 960 may include a thermocouple that is bonded to, or thermally coupled to, a MEMS device and/or a PZR strain sensor. In other embodiments, thermal sensor 960 indirectly measures a temperature of a MEMS device or a PZR strain sensor. For example, thermal sensor 960 may measure a total current in a Wheatstone bridge as described above with reference to FIGS. 7 and 8, where the total current is indicative of the temperature.

Mirror driver 902 receives a commanded angle θ*, and measurements of the MEMS angle and PZR temperature, and drives MEMS device 940 with voltage V. Examples of mirror drivers include TX mirror driver 350 and RX mirror driver 360 (FIG. 3). Mirror driver 902 includes dynamic angle controller 910, digital-to-analog converter (DAC) 920, class-D amplifier 930, and angle estimator 970.

One objective of mirror driver 902 is to regulate the true angle θ of the MEMS mirror 942 to the reference or commanded angle θ*. The dynamic angle controller 910 receives the commanded angle θ* and an estimated angle, and produces a commanded voltage V*. The commanded voltage V* is then transformed through the DAC 920 and the amplifier 930 into a true voltage V which is then applied to the coils of the MEMS mirror 942, thus causing rotational motion of the mirror. The dynamic angle controller generates the commanded voltage V* in an attempt to minimize the error between the reference angle θ* and the estimated angle θ, which in turn is a scaled version of the measurement from a PZR angle sensor (e.g., PZR strain sensor 950).

Angle estimator 970 includes analog-to-digital converters (ADCs) 971 and 975, nominal angle estimation block 972, temperature estimation block 976, and thermal compensation block 974. In operation, ADC 971 receives and digitizes the voltage signals corresponding to a measurement of the angle such as V_{PZR} from PZR strain sensor 950. The nominal estimation block 972 applies a known scale factor to arrive at a nominal angle estimate which is provided to thermal compensation block 974. ADC 975 receives and digitizes a voltage signal corresponding to a measurement of the temperature which is provided to temperature estimation circuit 976.

Temperature estimation block 976 produces the estimated temperature \hat{T} and provides it to thermal compensation circuit 974. In some embodiments, the temperature measurement signal is in the form of a voltage, such as Vₛ, and the estimated temperature \hat{T} is determined using Equation (8) above. In other embodiments, the temperature measurement signal is in the form of direct measurement, such as from a thermocouple, and the estimated temperature \hat{T} is determined by applying a known scale factor.

Thermal compensation block 974 receives the nominal angle estimate from the nominal estimation block 972 and the estimated temperature \hat{T}, applies thermal compensation, and produces a temperature compensated angle estimate \hat{θ}. In some embodiments, the temperature compensated angle estimation \hat{θ} can be determined as expressed in Equation (9).

$$\hat{θ} = \frac{{\hat{R}}_{0}}{{\hat{K}}_{0}} \hat{N} {V}_{P Z R} \hat{N} = \frac{{\hat{N}}_{r}}{{\hat{N}}_{θ}} \qquad ( 9 )$$

where the temperature dependent proportionality coefficient \hat{N} is comprised of the estimated terms \hat{N}ᵣ and \hat{N}_{θ} which may be computed using suitable mathematical models along with the estimated temperature \hat{T}. For instance, \hat{N}ᵣ may be obtained from Equation (7) and \hat{N}_{θ} may be estimated using a linear model as expressed in Equation (10) along with the temperature estimate \hat{T} from Equation (8).

$${\hat{N}}_{θ} = 1 + {\hat{α}}_{θ} ( \hat{T} - {\hat{T}}_{0} ) \qquad ( 10 )$$

As shown in Equation (9), the angle estimate \tilde{θ} may be determined by scaling the voltage signal V_{PZR} corresponding to the torsional movement of the MEMS mirror by the temperature dependent proportionality coefficient N along with other predetermined quantities \hat{R}₀ and \hat{K}₀.

In some embodiments, one or more circuits shown in FIG. 9 include a processor and memory similar to those shown in FIG. 3. For example, thermal compensation circuit 974 may include a processing system with one or more processors that perform the angle estimation (e.g., equation (13)). Also for example, dynamic angle controller 910, thermal compensation circuit 974, nominal angle estimation circuit 972, and temperature estimation circuit 976 may all be embodied by a system with one or more processors that perform all of the actions associated with the various embodiments described herein (e.g., all of the actions associated with the numbered equations above.

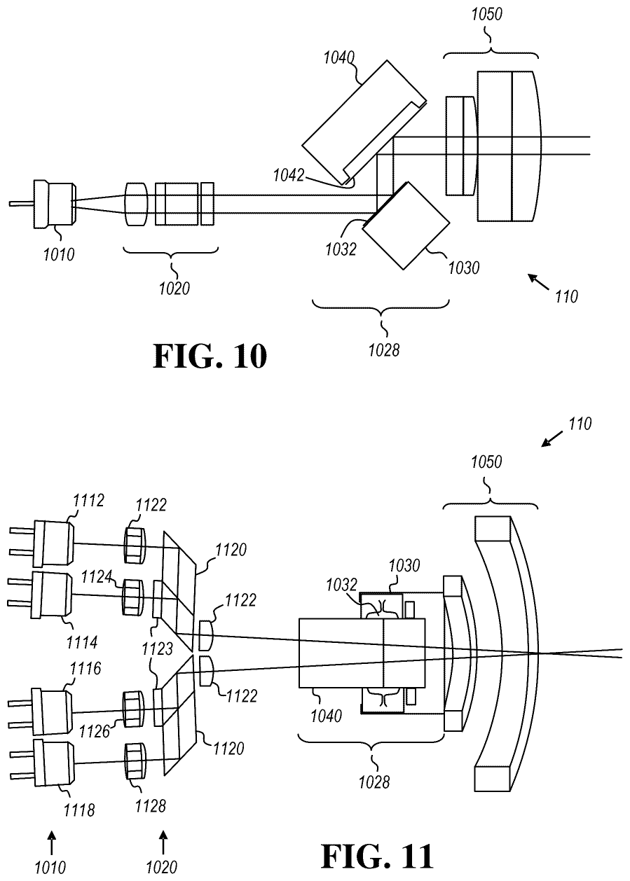

FIG. 10 shows a side view and FIG. 11 shows a top view of a transmit module in accordance with various aspects described herein. Transmit module 110 includes laser light source 1010, beam shaping optical devices 1020, scanner 1028, and exit optical devices 1050.

In some embodiments, laser light source 1010 sources nonvisible light such as infrared (IR) light. In these embodiments, the receive module 130 (FIG. 1) is able to detect the same wavelength of nonvisible light. For example, in some embodiments, light source 1010 may include a laser diode that produces infrared light with a wavelength of substantially 905 nanometers (nm), and receive module 130 detects reflected light pulses with a wavelength of substantially 905 nm. Also for example, in some embodiments, light source 1010 may include a laser diode that produces infrared light with a wavelength of substantially 940 nanometers (nm) and receive module 130 detects reflected light pulses with a wavelength of substantially 940 nm. The wavelength of light is not a limitation of the various embodiments. Any wavelength, visible or nonvisible, may be used without departing from the scope of the various embodiments described herein.

Laser light source 1010 may include any number or type of emitter suitable to produce a pulsed fanned laser beam. For example, in some embodiments, laser light source 1010 includes multiple laser diodes shown in FIG. 11 at 1112, 1114, 1116, and 1118. In some embodiments, the pulsed laser light produced by laser light source 1010 is combined, collimated, and focused by beam shaping optical devices 1020 to produce a pulsed fanned laser beam. For example, optical devices 1122 may collimate the laser beams on the fast (vertical) axis, polarization rotators 1123 and beam combiners 1120 may combine laser beams, and optical devices 1122 may form the pulsed laser beam into a fan on the slow (horizontal) axis. In some embodiments, the pulsed laser beam may be focused to form the fanned beam, and in other embodiments, the pulsed laser beam may be expanded to form the fanned beam. In some embodiments, optical devices 1122 may be line generator optics to form the pulsed laser beam into a fanned beam. In some embodiments, the pulsed laser beam may be collimated on the fast axis with <0.2 degrees of divergence and may be focused or expanded on the slow axis to diverge at a rate that produces a fan of substantially four degrees. Beam sizes and divergence values are not necessarily uniform across the various embodiments described herein; some embodiments have higher values, and some embodiments have lower values.

Scanner 1028 receives the pulsed fanned laser beam from optical devices 1020 and scans the pulsed fanned beam in two dimensions. In embodiments represented by FIGS. 10 and 11, scanner 1028 includes two separate scanning mirror assemblies 1030, 1040, each including a scanning mirror 1032, 1042, where each scanning mirror scans the beam in one dimension. For example, scanning mirror 1032 scans the pulsed fanned beam in the fast scan (vertical) direction, and scanning mirror 1042 scans the pulsed fanned beam in the slow scan (horizontal) direction.

Scanning mirror assemblies 1030, 1040 are driven by signals received from control circuit 140 (FIGS. 1, 3). For example, scanning mirror 1032 may scan in one dimension according to a first commanded angle on the first dimension as a result of being driven by a first control signal, and scanning mirror 1042 may scan in a second dimension according to a second commanded angle on the second dimension as a result of being driven by a second control signal. In some embodiments, the instantaneous angular deflection of scanning mirror assemblies 1030 and 1040 are independently controlled, resulting in a completely configurable field of view along with configurable scan rates.

Although scanner 1028 is shown including two scanning mirror assemblies, where each scans in a separate dimension, this is not a limitation of the various embodiments described herein. For example, in some embodiments, scanner 1028 is implemented using a single biaxial scanning mirror assembly that scans in two dimensions. In some embodiments, scanning devices uses electromagnetic actuation, achieved using a miniature assembly containing a MEMS die and small subassemblies of permanent magnets and an electrical interface, although the various embodiments are not limited in this respect.

In some embodiments, scanning mirror assemblies 1030, 1040 include one or more sensors to detect the angular position or angular extents of the mirror deflection (in one or both dimensions). For example, in some embodiments, scanning mirror assembly 1030 includes a plurality of piezoresistive strain sensors arranged in a Wheatstone bridge that delivers a voltage that is proportional to the deflection of the mirror on the fast-scan axis. Further, in some embodiments, scanning mirror assembly 1040 includes an additional plurality of piezoresistive strain sensors arranged in a Wheatstone bridge that delivers a voltage that is proportional to the deflection of the mirror on the slow-scan axis. In some embodiments, the resulting mirror position feedback signals 111 are provided back to transmit mirror driver 350 (FIG. 3) to allow phase locked operation. In these embodiments, transmit mirror driver 350 includes one or more feedback loops to modify the drive signals in response to the measured angular deflection of the mirror.

Exit optical devices 1050 operate on the scanning pulsed fanned laser beam as it leaves the transmit module. In some embodiments, exit optical devices 1050 perform field expansion. For example, scanning mirror assembly 1028 may scan through maximum angular extents of 20 degrees on the fast scan axis, and may scan through maximum angular extents of 40 degrees on the slow scan axis, and exit optical devices 1050 may expand the field of view to 30 degrees on the fast scan axis and 120 degrees on the slow scan axis. The relationship between scan angles of scanning mirrors and the amount of field expansion provided by exit optical devices 1050 is not a limitation of the various embodiments described herein.

In some embodiments, laser diodes 1112, 1114, 1116, and 1118 are high power multimode laser diodes. Multimode laser diodes typically have relatively large emitter areas that result in a beam that diverges faster on one axis than on the other axis. For example, an example 905 nm multimode laser diode may have a 10 um emitter on the fast axis and a 220 um emitter on the slow axis resulting in an emitted beam that inherently diverges faster on the slow axis. Various embodiments take advantage of this non-uniform beam shape by collimating the beam on the axis that naturally diverges more slowly, and focusing the beam into a fan on the axis that naturally diverges more quickly.

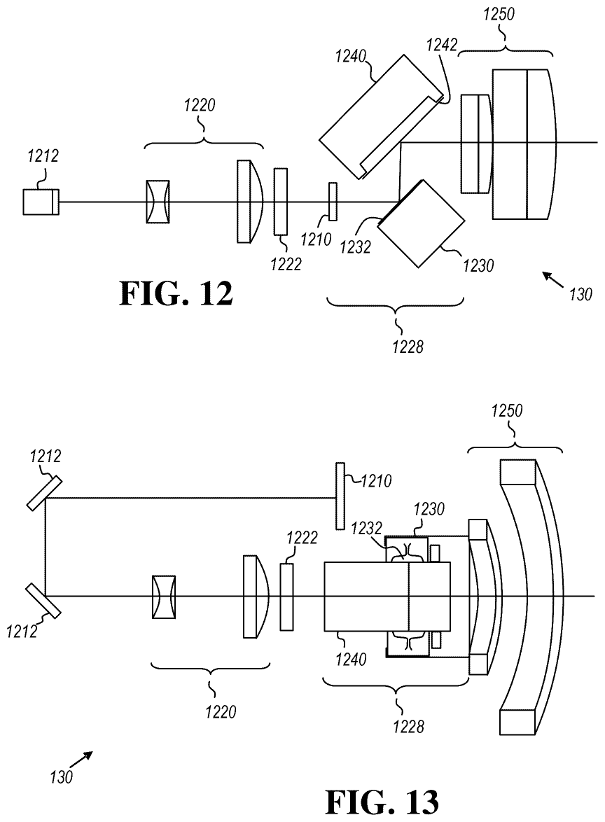

FIG. 12 shows a side view and FIG. 13 shows a top view of a receive module in accordance with various aspects described herein. Receive module 130 includes arrayed receiver 1210, fold mirrors 1212, imaging optical devices 1220, bandpass filter 1222, scanner 1228, and exit optical devices 1250.

Scanning mirror assemblies 1230 and 1240 are similar or identical to scanning mirror assemblies 1030 and 1040, and exit optical devices 1250 are similar or identical to exit optical devices 1050. Bandpass filter 1222 passes the wavelength of light that is produced by laser light source 1010 and blocks ambient light of other wavelengths. For example, in some embodiments, laser light source produces light at 905 nm, and bandpass filter 1222 passes light at 905 nm.

Imaging optical devices 1220 image a portion of the field of view onto arrayed receiver 1210 after reflection by fold mirrors 1212. For example, in some embodiments, optical devices 1220 image the area 126 (FIG. 1) onto arrayed receiver 1210. Because scanner 1228 is scanned synchronously with scanner 1028, arrayed receiver 1210 always collects light from the measurement points illuminated by the scanned pulsed fanned beam.

Arrayed receiver 1210 includes an array of light sensitive devices. The array of light sensitive devices may be one-dimensional or two-dimensional. For example, in some embodiments, arrayed receiver 1210 includes a 1×M array of PIN photodiodes, Silicon photomultipliers (SiPM), avalanche photodiodes (APD), or the like, where M is any integer. Also for example, in some embodiments, arrayed receiver 1210 includes a N×M array of PIN photodiodes, Silicon photomultipliers (SiPM), avalanche photodiodes (APD), or the like, where N and M are any integers. Any number of light sensitive devices may be included without departing from the scope of the various embodiments described herein. For example, in some embodiments, 16 light sensitive devices are included, and in other embodiments, 24 light sensitive devices are included.

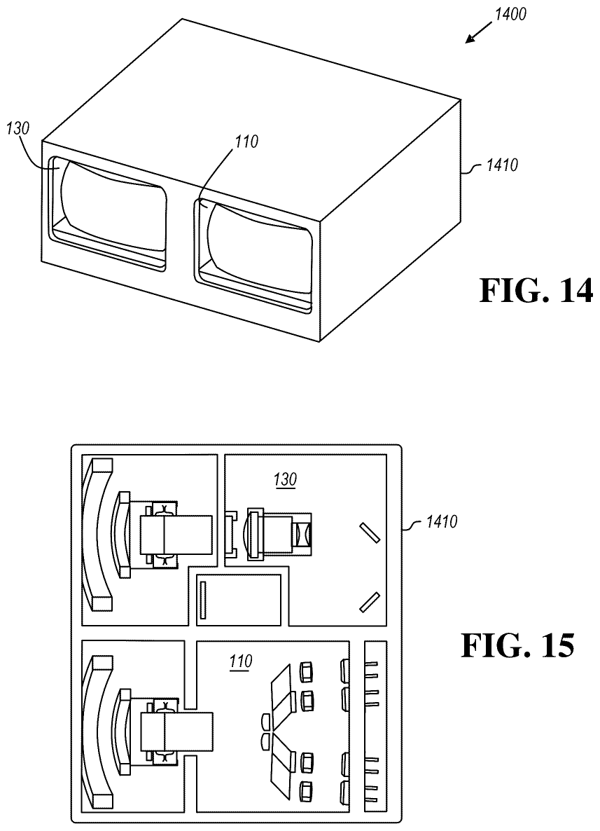

FIG. 14 shows a perspective view of an integrated photonics module in accordance with various embodiments described herein. Integrated photonics module 1400 is shown having a rectangular housing 1410 with transmit module 110 and receive module 130 placed side by side. In some embodiments, transmit module 110 and receive module 130 are placed one on top of the other. The relative orientation of transmit module 110 and receive module 130 is not a limitation of the various embodiments described herein.

FIG. 15 shows a cross sectional top view of the integrated photonics module of FIG. 14. Transmit module 110 and receive module 130 are shown side by side. In some embodiments, space is provided for electronics above and below the rearmost optical devices in integrated photonics module 1400. Any amount of system electronics may be included within module 1400. For example, in some embodiments, all components shown in FIG. 1 are included in module 1400. Also for example, in some embodiments, only control circuits and TOF measurement circuits are included in module 1400.

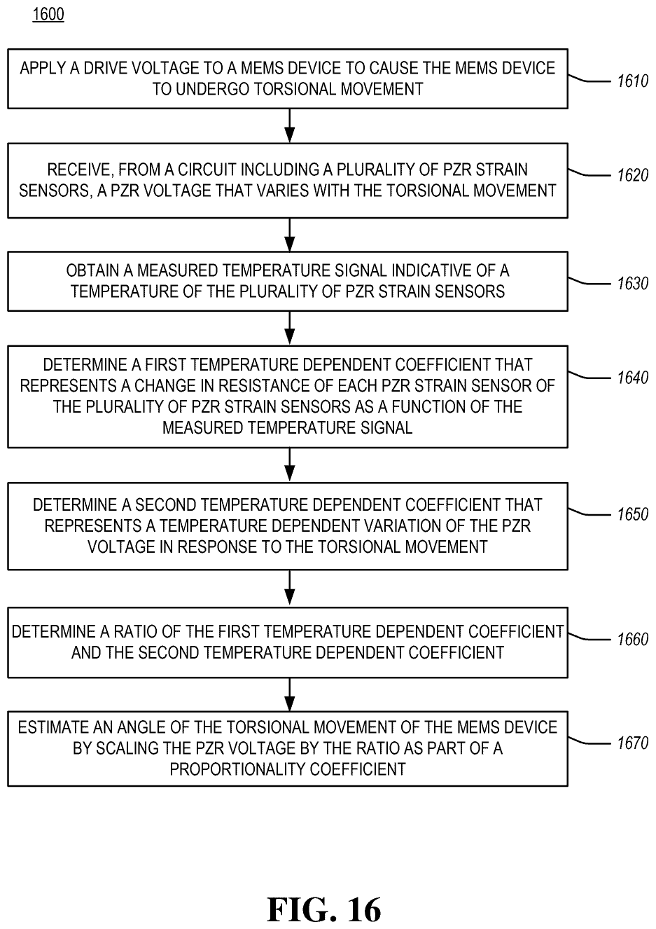

FIG. 16 shows a flow diagram of methods in accordance with various aspects described herein. In some embodiments, method 1600, or portions thereof, is performed by a MEMS system, a scanning LIDAR system, or a scanning LIDAR module. In other embodiments, method 1600 is performed by a series of circuits or an electronic system. Method 1600 is not limited by the particular type of apparatus performing the method. The various actions in method 1600 may be performed in the order presented or may be performed in a different order. Further, in some embodiments, some actions listed in FIG. 16 are omitted from method 1600.

Method 1600 is shown beginning with block 1610 in which a drive voltage is applied to a MEMS device to cause the MEMS device to undergo torsional movement. In some embodiments, this corresponds to mirror driver 902 applying drive voltage Von node 941 to MEMS device 940. Also in some embodiments, the actions of block 1610 correspond to control circuit 140 (FIG. 1) providing drive signals 145 and 147 to transmit module 110 and receive module 130, respectively. In some embodiments, a transmit scanning mirror and a receive scanning mirror are synchronously scanned in two dimensions. This corresponds to scanning mirror assemblies within transmit module 110 and receive module 130 synchronously scanning.

At 1620, a PZR voltage that varies with the torsional movement is received from a circuit including a plurality of piezoresistive strain sensors. In some embodiments, this corresponds to receiving V_{PZR} from a plurality of PZR strain sensors arranged in a Wheatstone bridge. For example, V_{PZR} as embodied in any of FIGS. 6-8 may be received.

At 1630, a measured temperature signal indicative of a temperature of the plurality of PZR sensors is obtained. In some embodiments, the measured temperature signal is a result of a direct temperature measurement, and in other embodiments, the measured temperature signal is a result of indirect measurements. An example of an indirect measurement that is indicative of a temperature includes determining a total current through a Wheatstone bridge that includes PZR strain sensors.

At 1640, a first temperature dependent coefficient that represents a change in resistance of each PZR strain sensor of the plurality of PZR strain sensors as a function of the measured temperature signal is determined. In some embodiments, this corresponds to determining a value for Nᵣ (T, To) as described above. At 1650, a second temperature dependent coefficient that represents a temperature dependent coefficient that represents a temperature dependent variation of the PZR voltage in response to the torsional movement is determined. In some embodiments, this corresponds to determining a value for Ne (T, To) as described above.

At 1660, a ratio of the first temperature dependent coefficient and the second temperature dependent coefficient is determined, and at 1670, an instantaneous angle of the torsional movement of the MEMS device is estimated by scaling the PZR voltage by the ratio as part of a proportionality constant.

While for purposes of simplicity of explanation, the respective processes are shown and described as a series of blocks in FIG. 16, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A system, comprising:
a micro-electromechanical systems (MEMS) device capable of torsional movement;
a circuit including a plurality of piezoelectric (PZR) strain sensors coupled to the MEMS device to produce a first voltage that varies with the torsional movement;
a thermal sensor to produce a measured temperature signal indicative of a temperature of the plurality PZR strain sensors;
a processing system including a processor, the processing system coupled to receive the first voltage and the measured temperature signal; and
a memory that stores executable instructions that, when executed by the processing system, facilitate performance of operations, the operations comprising:
determining a proportionality coefficient that represents a temperature dependent variation of the first voltage in response to the torsional movement; and
estimating an instantaneous angle of the torsional movement of the MEMS device by scaling the first voltage by the proportionality coefficient.

2. The system of claim 1, wherein the thermal sensor comprises a thermocouple.

3. The system of claim 1, wherein the circuit including the plurality of piezoelectric strain sensors includes a Wheatstone bridge.

4. The system of claim 3, wherein the thermal sensor includes a second circuit to measure a total current in the Wheatstone bridge.

5. The system of claim 4, wherein the second circuit includes a shunt resistor in series with the Wheatstone bridge.

6. The system of claim 4, wherein the second circuit includes a current mirror.

7. The system of claim 1, wherein the operations further comprise characterizing a temperature dependency of a resistance of a sample piezoelectric strain sensor in response to torsional movement, and wherein the determining the proportionality coefficient comprises evaluating the temperature dependency at the temperature of the plurality of PZR strain sensors indicated by the measured temperature signal.

8. The system of claim 1, wherein the operations further comprise commanding the MEMS device to undergo torsional movement at a commanded angle.

9. The system of claim 8, wherein the operations further comprise determining the commanded angle based at least in part on the instantaneous angle estimated using the proportionality coefficient.

10. A system, comprising:
a micro-electromechanical systems (MEMS) device capable of torsional movement;
a circuit including a plurality of piezoelectric (PZR) strain sensors coupled to the MEMS device to produce a first voltage that varies with the torsional movement;
a thermal sensor to produce a measured temperature signal indicative of a temperature of the plurality of PZR strain sensors;
a processing system including a processor, the processing system coupled to receive the first voltage and the measured temperature signal; and
a memory that stores executable instructions that, when executed by the processing system, facilitate performance of operations, the operations comprising:
determining a first temperature dependent coefficient that represents a change in resistance of each PZR strain sensor of the plurality of PZR strain sensors as a function of the measured temperature signal;
determining a second temperature dependent coefficient that represents a temperature dependent variation of the first voltage in response to the torsional movement;
determining a ratio of the first temperature dependent coefficient to the second temperature dependent coefficient; and
estimating an instantaneous angle of the torsional movement of the MEMS device by scaling the first voltage by the ratio as part of a proportionality coefficient.

11. The system of claim 10, wherein the thermal sensor comprises a thermocouple.

12. The system of claim 10, wherein the circuit including the plurality of PZR strain sensors includes a Wheatstone bridge.

13. The system of claim 12, wherein the thermal sensor includes a second circuit to measure a total current in the Wheatstone bridge.

14. The system of claim 13, wherein the second circuit includes a shunt resistor in series with the Wheatstone bridge.

15. The system of claim 13, wherein the second circuit includes a current mirror.

16. The system of claim 10, wherein the operations further comprise characterizing a temperature dependency of a resistance of a sample piezoelectric strain sensor in response to torsional movement, and wherein the determining the second temperature dependent coefficient comprises evaluating the temperature dependency at the temperature of the PZR strain sensors indicated by the measured temperature signal.

17. The system of claim 10, wherein the operations further comprise commanding the MEMS device to undergo torsional movement at a commanded angle.

18. The system of claim 17, wherein the operations further comprise determining the commanded angle based at least in part on the instantaneous angle estimated using the proportionality coefficient.

19. A Light Detection and Ranging (LIDAR) system, comprising:
a laser light source to produce laser light pulses;
a transmit mirror to reflect the laser light pulses, the transmit mirror being mounted to a first micro-electromechanical systems (MEMS) device capable of torsional movement;
a light detector;
a receive mirror to reflect received laser light pulses to the light detector, the receive mirror being mounted to a second MEMS device capable of torsional movement;
a first circuit including a first plurality of piezoelectric (PZR) strain sensors coupled to the first MEMS device to produce a first voltage that varies with the torsional movement of the first MEMS device;
a second circuit including a second plurality of PZR strain sensors coupled to the second MEMS device to produce a second voltage that varies with the torsional movement of the second MEMS device;
a first thermal sensor to produce a first measured temperature signal indicative of a first temperature of the first plurality of PZR strain sensors;
a second thermal sensor to produce a second measured temperature signal indicative of a second temperature of the second plurality of PZR strain sensors;
a processing system including a processor, the processing system coupled to receive the first and second voltages and the first and second measured temperature signals; and
a memory that stores executable instructions that, when executed by the processing system, facilitate performance of operations, the operations comprising:
determining separate proportionality coefficients for the first and second MEMS devices that represents temperature dependent variations of the first voltage and the second voltage in response to torsional movement; and
estimating instantaneous angles of the torsional movement of the first and second MEMS devices by scaling the first voltage and the second voltage by the separate proportionality coefficients.

20. The LIDAR system of claim 19, wherein the first and second circuits comprise Wheatstone bridges, and the first and second thermal sensors include current measurement circuits to measure total currents in the Wheatstone bridges.
